(19) United States
(12) Patent Application Publication
(10) Pub. No.: US 2013/0066635 A1
(43) Pub. Date: Mar. 14, 2013

(54) APPARATUS AND METHOD FOR CONTROLLING HOME NETWORK SERVICE IN PORTABLE TERMINAL

(71) Applicants: Jong-Seok KIM, Seoul (KR); Jin Park, Yongin-si (KR)

(72) Inventors: Jong-Seok KIM, Seoul (KR); Jin Park, Yongin-si (KR)

(73) Assignee: Samsung Electronics Co., Ltd., Suwon-si (KR)

(21) Appl. No.: 13/608,265

(22) Filed: Sep. 10, 2012

(30) Foreign Application Priority Data
Sep. 8, 2011 (KR) 10-2011-0090992

(51) Int. Cl. G06F 3/01; G06F 15/16; G10L 15/00

(52) U.S. Cl. 704/270.1; 715/740; 704/E15.005

(57) ABSTRACT

An apparatus and a method, which set a remote control command for controlling a home network service in a portable terminal are provided. The apparatus includes a memory for storing configuration types of a remote control command in a set order in a home network service; and a controller for setting the remote control command including the input configuration types of the remote control command and transmitting the remote control command, when the configuration types of the remote control command are input in the set order in the home network service.

### PRIORITY

This application claims priority under 35 U.S.C. §119(a) to a Patent Application filed in the Korean Intellectual Property Office on Sep. 8, 2011 and assigned Serial No. 10-2011-0090992, the entire disclosure of which is incorporated herein by reference.

### BACKGROUND OF THE INVENTION

1. Field of the Invention

The present invention relates generally to an apparatus and method for controlling a home network service in a portable terminal, and more particularly setting a remote control command for controlling a home network service in a portable terminal.

2. Description of the Related Art

Generally, the term “home network service” refers to a service capable of remotely controlling household appliances, such as an electronic measuring device, a television, a video cassette recorder, a refrigerator, an air conditioner, a washing machine, a microwave oven, an electronic curtain, a boiler, a home theater, and the like.

For example, at a desired point in time while a user is out of the house, the user may either operate a video cassette recorder and record a desired program, operate a thermostat of a boiler and control the temperature of a room or the temperature of water in a bathroom, remotely lock a door, or turn off a gas valve. In this manner, household appliances in a home can automatically be managed by using a home network service.

Moreover, the home network service as described above can be conveniently controlled by using a portable terminal.

However, the home network service using the portable terminal employs a scheme for performing the home network service by simply transmitting only one command like “turn an air conditioner on” from the portable terminal to a relevant home server. Therefore, the portable terminal needs a user interface to control the home network service, which is similar to a natural human command like “Please turn an air conditioner on in the bedroom at 2 o'clock.”

### SUMMARY OF THE INVENTION

Accordingly, an aspect of the present invention is to solve the abovementioned problems, and to provide an apparatus and a method, which can set a remote control command for controlling a home network service in a portable terminal.

Moreover, the present invention provides an apparatus and a method for controlling a home network service in a portable terminal that can easily configure a complex remote control command by receiving as input a remote control command for controlling the home network service in a preset order.

Further, the present invention provides an apparatus and method for controlling a home network service in a portable terminal that enable a user to input a remote control command for controlling the home network service through a voice command following a preset order.

In accordance with an aspect of the present invention, an apparatus for controlling a home network service in a portable terminal is provided. The apparatus includes a memory for storing configuration types of a remote control command in a set order in a home network service; and a controller for setting the remote control command including the input configuration types of the remote control command and transmitting the remote control command, when the configuration types of the remote control command are input in the set order in the home network service.

In accordance with another aspect of the present invention, a method for controlling a home network service in a portable terminal is provided. The method includes selecting setting of a remote control command in a home network service; and setting the remote control command including the input configuration types of the remote control command and transmitting the remote control command, when the configuration types of the remote control command are input in a set order in a mode of setting a remote control command.

### BRIEF DESCRIPTION OF THE DRAWINGS

The above and other aspects, features, aspects, and advantages of the present invention will be more apparent from the following detailed description taken in conjunction with the accompanying drawings, in which:

FIG. 1 is a block diagram illustrating the configuration of a portable terminal according to an embodiment of the present invention;

FIG. 2 is a flowchart illustrating a method for controlling a home network service through a command for remotely controlling a menu by a portable terminal according to an embodiment of the present invention;

FIG. 3 is illustrates a method for controlling a home network service through a command for remotely controlling a menu by a portable terminal according to an embodiment of the present invention; and

FIG. 4 is a flowchart illustrating a method for controlling a home network service through a voice command for remote control by a portable terminal according to an embodiment of the present invention.

### DETAILED DESCRIPTION OF EMBODIMENTS OF THE PRESENT INVENTION

Hereinafter, embodiments of the present invention will be described in detail with reference to the accompanying drawings. It should be noted that, in the accompanying drawings, the same elements will be designated by the same reference numerals throughout the following description and drawings although they may be shown in different drawings.

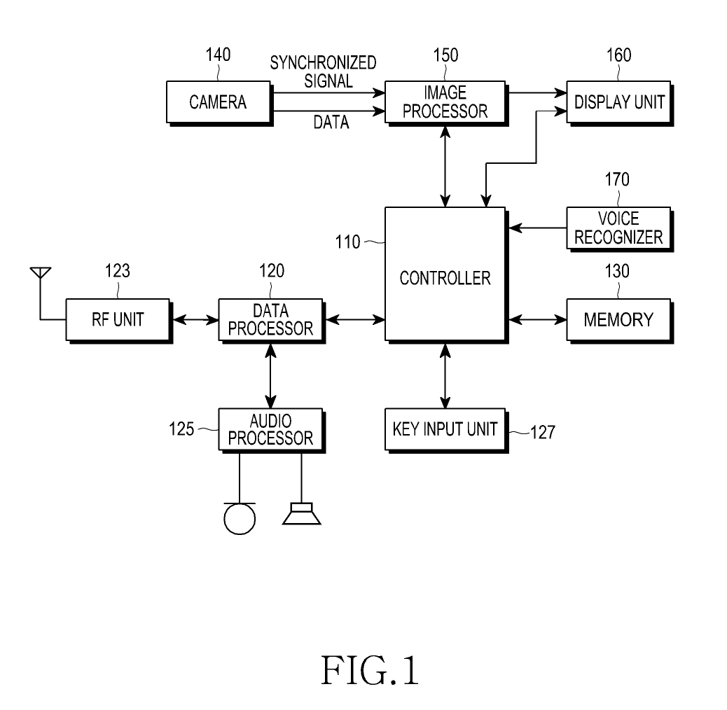

FIG. 1 is a block diagram illustrating the configuration of a portable terminal according to an embodiment of the present invention.

Referring to FIG. 1, an RF unit 123 performs a wireless communication function in the portable terminal. The RF unit 123 includes an RF transmitter for upconverting the frequency of a signal to be transmitted and then amplifying the frequency-upconverted signal, an RF receiver for low-noise amplifying a received signal and then downconverting the frequency of the low-noise amplified signal, etc. A data processor 120 includes a transmitter for encoding and modulating a signal to be transmitted, a receiver for demodulating and decoding a signal received by the RF unit 123, and the like. Namely, the data processor 120 may include a modem (modulator/demodulator) and a codec (coder/decoder). The codec includes a data codec for processing packet data and the like, and an audio codec for processing audio signals including voice and the like. An audio processor 125 reproduces a received audio signal, which has been output from the audio codec of the data processor 120, or transmits an audio signal to be transmitted, which is generated from a microphone, to the audio codec of the data processor 120.

A key input unit 127 may include keys for inputting numbers and text information and function keys for setting various functions.

A memory 130 may include a program memory and a data memory. The program memory may store programs for controlling general operations of the portable terminal and programs which are used to set a remote control command by using configuration types of a remote control command received as input in a preset order in a home network service mode according to an embodiment of the present invention. Moreover, the data memory temporarily stores data generated while the programs executed.

Also, according to an embodiment of the present invention, the memory 130 sequentially stores a time (when), a place (where), an object (what) and an operation (how) as configuration types of the remote control command. The place, the object and the operation are stored as required components and, the time is stored as an optional component.

A controller 110 controls an overall operation of the portable terminal.

According to an embodiment of the present invention, in a mode of setting a remote control command of a home network service, when a time item corresponding to an optional component is selected, the controller 110 sets a selected time as a time to transmit a remote control command. On the other hand, when the time item is not selected, the controller 110 sets a current time as a time to transmit a remote control command.

Furthermore, according to an embodiment of the present invention, in the mode of setting a remote control command of the home network service, after the time item has been selected and a relevant reservation time is set, or when the time item has not been selected, the controller 110 performs a control operation for displaying the types of places for a remote control. When a relevant place is selected from among the displayed places, the controller 110 performs a control operation to display the types of objects located at the selected place.

When an object is selected, the controller 110 performs a control operation to display the types of operations that the selected object may perform. When a relevant operation is selected, the controller 110 sets a remote control command configured by the place, the object and the operation, which have been sequentially selected, transmits the set remote control command at the selected reservation time or at the current time.

Also, according to an embodiment of the present invention, in a mode of setting a voice command for remote control of the home network service, the controller 110 performs an operation for analyzing a voice command for remote control received from the voice recognizer 170. When time is detected from the analyzed voice command for remote control, the controller 110 performs an operation for setting the detected time as a time of transmitting a remote control command. On the other hand, when a time is not detected from the analyzed voice command for remote control, the controller 110 sets a current time as the time of transmitting a remote control command.

Also, according to an embodiment of the present invention, when the place is detected from the voice command for remote control, after the time is detected in the mode of setting a voice command for remote control of the home network service, or in a state where the time is not detected in the mode of setting a voice command for remote control of the home network service, the controller 110 detects an object from the voice command for remote control. On the other hand, when the place is not detected from the voice command for remote control, the controller 110 performs an operation for outputting a voice message requesting the input of a place.

Further, according to an embodiment of the present invention, when the detected object is included in types of objects located at the detected place, the controller 110 detects an operation from the voice command for remote control. When an object is not detected from the voice command for remote control, or when the detected object is not included in the types of objects located at the detected place, the controller 110 performs an operation for outputting a voice message requesting the input of an object.

Then, according to an embodiment of the present invention, when the detected operation is included in the types of operations that the detected object performs, the controller 110 sets a remote control command including the place, the object and the information, which have been sequentially detected, and transmits the set remote control command at the detected time or at the current time. On the other hand, when an operation is not detected from the voice command for remote control or when the detected operation is not included in the types of operations that the detected object may perform, the controller 110 performs an operation for outputting a voice message requesting the input of an operation.

In the mode of setting a voice command for remote control of the home network service, the voice recognizer 170 recognizes an input voice command, and converts the recognized voice command to a voice command for remote control corresponding to a character command and transmits the converted voice command for remote control to the controller 110.

A camera 140 includes a camera sensor for capturing image data and converting the captured light signal to an electrical signal, and a signal processor for converting the analog image signal, which has been captured by the camera sensor, to digital data. The camera sensor is a Charge-Coupled Device (CCD) sensor or a Complementary Metal-Oxide Semiconductor (CMOS) sensor, and the signal processor may be implemented by using a Digital Signal Processor (DSP). Further, the camera sensor and the signal processor may be implemented as one unit, or as separate elements.

An image processor 150 performs Image Signal Processing (ISP) for displaying an image signal, which has been output from the camera 140, by a display unit 160. The term ISP refers to the execution of functions including a gamma correction, an interpolation, a spatial change, an image effect, an image scale, Auto White Balance (AWB), Auto Exposure (AE), Auto Focus (AF), and the like. Thus, the image processor 150 processes the image signal output from the camera 140, on a frame-by-frame basis, and outputs the frame image data in such a manner so as to meet the characteristics and the size of the display unit 160. Further, the image processor 150 includes an image codec, and compresses the frame image data displayed by the display unit 160 in a set scheme, or restores the compressed frame image data to an original frame image data. The image codec may be implemented by using either a Joint Photographic Coding Experts Group (JPEG) codec, an Moving Picture Experts Group 4-(MPEG-4) codec, a Wavelet codec, or the like. It is assumed that the image processor 150 includes an On-Screen Display (OSD) function. The image processor 150 may output on-screen display data according to the size of a screen displayed under the control of the controller 110.

The display unit 160 displays an image signal, which has been output from the image processor 150, on a screen thereof, and displays user data which has been output from the controller 110. The display unit 160 may be a Liquid Crystal Display (LCD), and thus may include an LCD controller, a memory capable of storing image data, an LCD display element, and the like. When the LCD employs a touchscreen, the display unit 160 operates as an input unit. At this time, the display unit 160 displays keys which are identical to those of the key input unit 127.

Also, according to an embodiment of the present invention, in the mode of setting a voice command for remote control of the home network service, the display unit 160 sequentially displays configuration types of a remote control command.

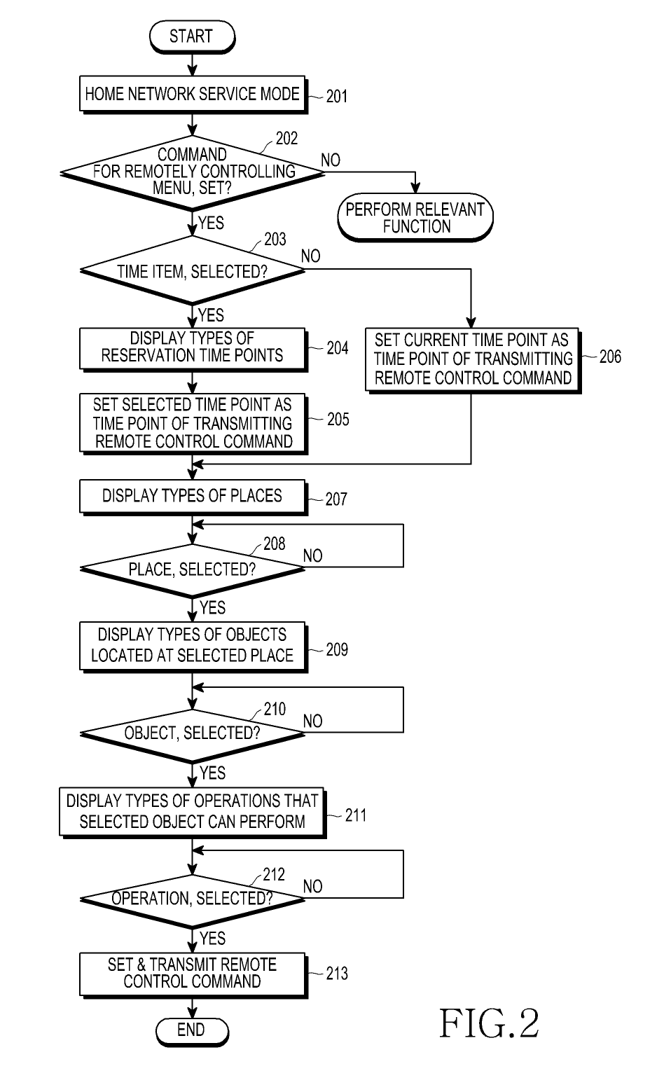

In the portable terminal as described above, an operation for controlling the home network service will be described in detail with reference to FIGS. 2 to 4.

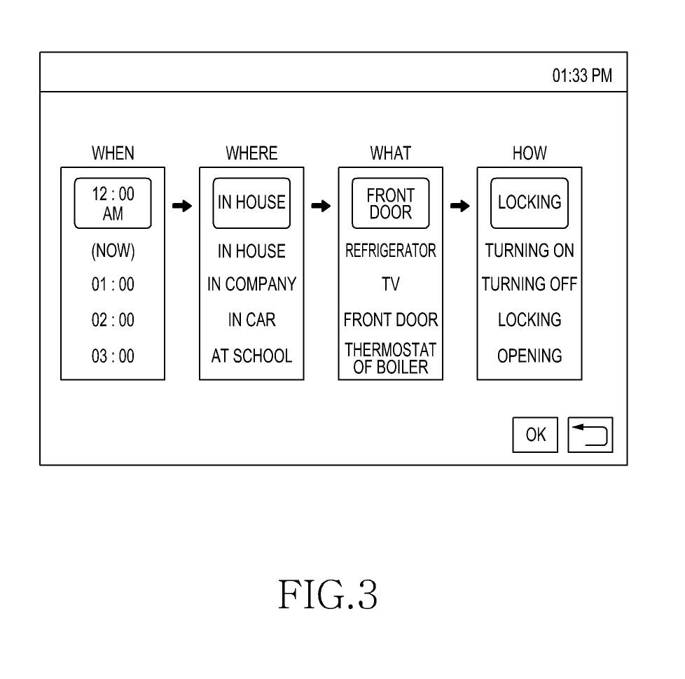

FIG. 2 is a flowchart illustrating a method for controlling a home network service through a command for remotely controlling a menu by a portable terminal according to an embodiment of the present invention. FIG. 3 illustrates a method for controlling a home network service through a command for remotely controlling a menu by a portable terminal according to an embodiment of the present invention.

An embodiment of the present invention will now be described in detail with reference to FIGS. 2 to 4 together with FIG. 1.

Referring to FIG. 2, when setting of a command for remotely controlling a menu is selected in step 201 corresponding to a home network service mode, the controller 110 detects the selection of the setting of the command for remotely controlling a menu in step 202, and changes to a mode of setting a command for remotely controlling a menu.

When a time item corresponding to an optional component is selected in the mode of setting a command for remotely controlling a menu, the controller 110 detects the selection of the time item in step 203, and proceeds to step 204 where types of reservation times of transmitting a remote control command are displayed.

When a relevant time is selected from among the reservation times displayed in step 204, the controller 110 detects the selection of the relevant time, and proceeds to step 205 where the selected time is set as a time of transmitting a remote control command.

On the other hand, when the time item is not selected, the controller 110 detects, in step 203, that the time item has not been selected, and proceeds to step 206 where a current time is set as the time of transmitting a remote control command.

After step 205 or step 206, the controller 110 proceeds to step 207 where the controller 110 controls the display unit 160 to display types of places among components of remote control commands in a preset order. Otherwise, the types of places may be displayed according to the selection of a place item by a user.

When a relevant place is selected from among the places displayed in step 207, the controller 110 detects the selection of the relevant place in step 208, and proceeds to step 209 where only types of objects located at the selected place are displayed.

When a relevant object is selected from among the objects displayed in step 209, the controller 110 detects the selection of the relevant object in step 210, and proceeds to step 211 where only types of operations that the selected object may perform are displayed.

When a relevant operation is selected from among the operations displayed in step 211, the controller 110 detects the selection of the relevant operation in step 212, and sets a remote control command including the place, the object and the operation, which have been sequentially selected, as packet data, and proceeds to step 213. In step 213, the controller 110 performs a control operation for transmitting the remote control command at the reservation time which has been set in step 205, or at the current time which has been set in step 206.

FIG. 3 illustrates the operation for sequentially selecting configuration types (times, places, objects and operations) of remote control commands in the menu as shown in FIG. 2.

When a time item (when) corresponding to an optional component is selected and a reservation time (12:00 p.m.) is selected in the mode of setting a command for remotely controlling a menu, the types of places are displayed as place items (where). When a relevant place (in a house) is selected from among the places, types of objects located at the selected place (in a house) are displayed as object items (what). When a relevant object (a front door) is selected from among the objects, types of operations that the selected object (a front door) may perform is displayed as operation items (how). When a relevant operation (locking) is selected from among the operations, a remote control command, which has been designated as “locking a front door in a house” is first set as packet data, and then, the set remote control command is transmitted to a relevant home server at 12:00 p.m.

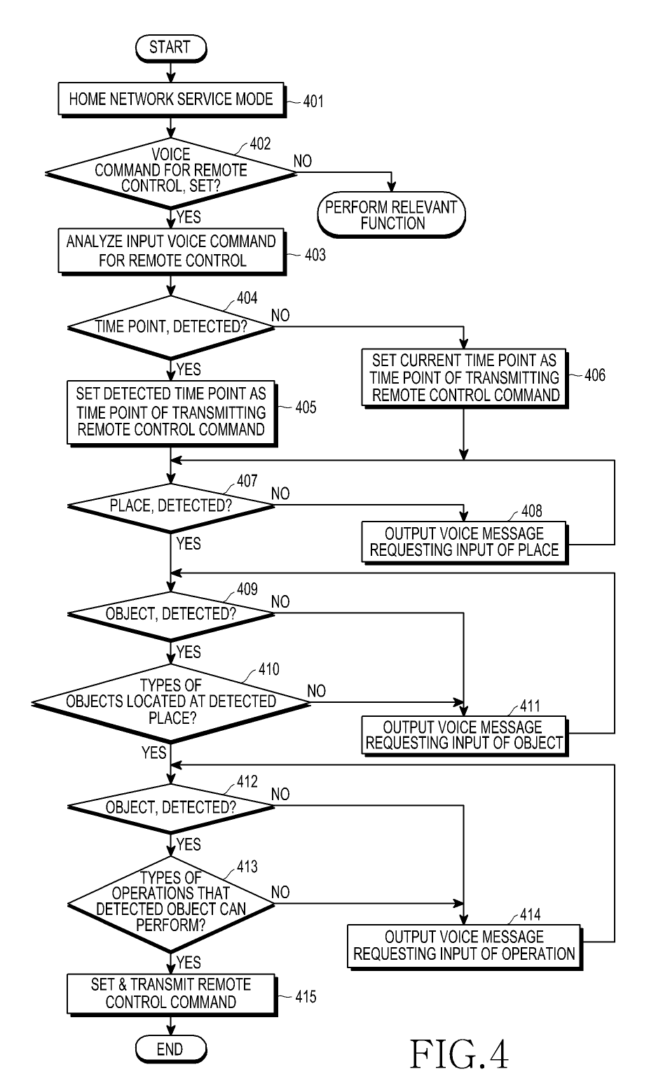

FIG. 4 is a flowchart illustrating a method for controlling a home network service through a voice command for remote control by a portable terminal according to an embodiment of the present invention.

Hereinafter, an embodiment of the present invention will be described in detail with reference to FIG. 4 together with FIG. 1.

Referring to FIG. 4, when setting of a voice command for remote control is selected in step 401 corresponding to a home network service mode, the controller 110 detects the selection of the setting of the voice command for remote control in step 402, and changes to a mode of setting a voice command for remote control.

In the mode of setting a voice command for remote control, the controller 110 proceeds to step 403. In step 403, the controller 110 controls the voice recognizer 170 to analyze a voice command for remote control which is input by a user.

When a time corresponding to an optional component is detected from the analyzed voice command for remote control, the controller 110 detects the detection of the time in step 404, and proceeds to step 405 where the detected time is set as a time of transmitting a remote control command.

On the other hand, when the time item is not detected from the analyzed voice command for remote control, the controller 110 detects, in step 404, that the time item has not been detected from the analyzed voice command for remote control, and proceeds to step 406 where a current time is set as the time of transmitting a remote control command.

After step 405 or step 406, the controller 110 determines whether a place is detected from the analyzed voice command for remote control. When the place is not detected from the analyzed voice command for remote control, the controller 110 detects, in step 407, that the place has not been detected from the voice command for remote control, and proceeds to step 408. In step 408, the controller 110 performs a control operation for outputting a voice message requesting the input of a place.

On the other hand, when the place is detected from the analyzed voice command for remote control, the controller 110 detects the detection of the place in step 407, and determines whether an object is detected from the analyzed voice command for remote control. When the object is not detected from the voice command for remote control, the controller 110 detects, in step 409, proceeds to step 411. In step 411, the controller 110 performs a control operation for outputting a voice message requesting the input of an object.

On the other hand, when the object is detected from the voice command for remote control, the controller 110 detects the object in step 409, and determines whether the detected object is included in the types of objects located at the place detected in step 407. When the detected object is not included in the types of objects located at the detected place, the controller 110 detects, in step 410, that the object is not included in the types of objects located at the detected place, and proceeds to step 411. In step 411, the controller 110 performs an operation to notify that the detected object is not included in the types of objects located at the detected place, and output a voice message requesting the input of an object.

On the other hand, when the detected object is included in the types of objects located at the place detected in step 407, the controller 110 detects, in step 410, that the detected object is included in the types of objects located at the place detected in step 407, and determines whether an operation is detected from the analyzed voice command for remote control. When the operation is not detected from the analyzed voice command for remote control, the controller 110 detects, in step 412, that the operation has not been detected from the analyzed voice command for remote control, and proceeds to step 414. In step 414, the controller 110 performs a control operation for outputting a voice message requesting the input of an operation.

On the other hand, when the operation is detected from the analyzed voice command for remote control, the controller 110 detects the detection of the operation in step 412, and determines whether the detected operation is included in types of operations that the object detected in step 409 may perform. When the detected operation is not included in the types of operations that the object detected in step 409 may perform, the controller 110 detects, in step 413, that the operation is not included in the types of operations that the object detected in step 409 may perform, and proceeds to step 414. In step 414, the controller 110 performs an operation notifying that the detected operation is not included in the types of operations that the object detected in step 409 may perform, and outputting a voice message requesting the input of an operation.

On the other hand, when the detected operation is included in the types of operations that the object detected in step 409 may perform, the controller 110 detects, in step 413, that the operation is included in the types of operations that the object detected in step 409 may perform, and proceeds to step 415. In step 415, the controller 110 performs an operation setting a remote control command including the place, the object and the operation, which have been sequentially detected, as packet data, and transmitting the remote control command at a reservation time which has been set in step 405 set or at the current time which has been set in step 406.

For example, in the mode of setting a voice command for remote control, when the voice command for remote control “lock the front door in my house” is input, first, because a time has not been detected, a current time is set as a component of a remote control command, “my house” is detected as a place, “the front door” is detected as an object, and “lock” is detected as an operation. Therefore, the remote control command including the place (my house), the object (the front door) and the operation (locking) is set as packet data, and the set remote control command is transmitted to a relevant home server at the current time.

Otherwise, in the mode of setting a voice command for remote control, when the voice command for remote control “lock the front door” is input, first, because a time has not been detected, a current time is set as a component of a remote control command. Then, because a place has not been detected, a voice message requesting the input of a place is output. Then, when a user inputs the place voice command “my house,” “my house” is detected as a place, “the front door” is detected as an object, and “lock” is detected as an operation. Therefore, the remote control command including the place (my house), the object (a front door) and the operation (locking) is set as packet data, and the set remote control command is transmitted to a relevant home server at the current time.

In the present invention as described above, an apparatus and a method for controlling a home network service in a portable terminal can easily configure a complex remote control command by receiving as input the configuration types of a remote control command in a preset order. Moreover, the apparatus and the method enable a user to input the configuration types of a remote control command through a voice in a preset order.

While the present invention has been shown and described with reference to certain embodiments and drawings of the portable terminal, it will be understood by those skilled in the art that various changes in form and details may be made therein without departing from the spirit and scope of the invention as defined by the appended claims and their equivalents.

What is claimed is:

1. An apparatus for controlling a home network service in a portable terminal, the apparatus comprising:
a memory for storing configuration types of a remote control command in a set order in a home network service; and
a controller for setting the remote control command including the input configuration types of the remote control command and transmitting the remote control command, when the configuration types of the remote control command are input in the set order in the home network service.

2. The apparatus of claim 1, wherein the configuration types of the remote control command comprise in sequence a time, a place, an object and an operation, and
wherein the place, the object and the operation correspond to required components.

3. The apparatus of claim 1, wherein the controller displays types of objects located at a selected place when the place is selected in a mode of setting a command for remotely controlling a menu of the home network service; displays types of operations to be performed by a selected object when the object is selected; and sets the remote control command including the selected place, the selected object and a selected operation, when the operation is selected.

4. The apparatus of claim 3, wherein the controller sets a selected time as a time of transmitting the remote control command when the time is selected before selection of the place, and sets a current time as the time of transmitting the remote control command when the time is not selected before the selection of the place.

5. The apparatus of claim 1, wherein, in a mode of setting a voice command for remote control of the home network service, the controller detects a place, an object and an operation from an input voice command for remote control, and sets the remote control command including the detected place, the detected object and the detected operation.

6. The apparatus of claim 5, wherein the controller performs an operation for outputting a voice message requesting an input of a place when the place is not detected from the voice command for the remote control.

7. The apparatus of claim 5, wherein the controller detects the operation when the object detected from the voice command for the remote control is included in types of objects located at the detected place, and sets the remote control command when the detected operation is included in types of operations to be performed by the detected object.

8. The apparatus of claim 7, wherein the controller performs an operation for outputting a voice message requesting an input of an object, when the object is not detected from the voice command for the remote control or when the detected object is not included in the types of the objects located at the detected place.

9. The apparatus of claim 7, wherein the controller performs an operation for outputting a voice message requesting an input of an operation, when the operation is not detected from the voice command for the remote control or when the detected operation is not included in the types of the operations to be performed by the detected object.

10. The apparatus of claim 5, wherein the controller sets a detected time as a time of transmitting the remote control command when the time is detected from the voice command for the remote control before the place, and performs an operation for setting a current time as the time of transmitting the remote control command when the time is not detected from the voice command for the remote control before the place.

11. A method for controlling a home network service in a portable terminal, the method comprising:
selecting setting of a remote control command in a home network service; and
setting the remote control command including the input configuration types of the remote control command and transmitting the remote control command, when the configuration types of the remote control command are input in a set order in a mode of setting a remote control command.

12. The method of claim 11, wherein the configuration types of the remote control command comprise in sequence a time, a place, an object and an operation, wherein the place, the object and the operation correspond to required components.

13. The method of claim 11, wherein transmitting the set remote control command comprises:
displaying types of objects located at a selected place when the place is selected in a mode of setting a command for remotely controlling a menu of the home network service;
displaying types of operations to be performed by a selected object when the object is selected from among the displayed types of the objects; and
setting the remote control command comprising the selected place, the selected object and a selected operation, when the operation is selected among the displayed types of the operations.

14. The method of claim 13, further comprising:
setting a selected time as a time of transmitting the remote control command when the time is selected before selection of the place; and
setting a current time as the time of transmitting the remote control command when the time is not selected before the selection of the place.

15. The method of claim 11, wherein transmitting the set remote control command comprises:
analyzing an input voice command for remote control when the voice command for the remote control is input, in a mode of setting a voice command for remote control of the home network service; and
setting the remote control command including a detected place, a detected object and a detected operation, when the place, the object and the operation are detected from the voice command for the remote control.

16. The method of claim 15, wherein setting the remote control command comprises:
detecting an object from the voice command for the remote control when the place is detected from the voice command for the remote control;
identifying whether the detected object is included in types of objects located at the detected place, when the object is detected;
detecting an operation from the voice command for the remote control when the detected object is included in the types of the objects located at the detected place;
identifying whether the detected operation is included in types of operations to be performed by the detected object, when the operation is detected; and
setting the remote control command comprising the detected place, the detected object and the detected operation, when the detected operation is included in the types of the operations to be performed by the detected object.

17. The method of claim 16, further comprising:
outputting a voice message requesting an input of a place when the place is not detected from the voice command for the remote control.

18. The method of claim 16, further comprising:
outputting a voice message requesting an input of an object, when the object is not detected from the voice command for the remote control or when the detected object is not included in the types of the objects located at the detected place.

19. The method of claim 16, further comprising:
outputting a voice message requesting an input of an operation, when the operation is not detected from the voice command for the remote control or when the detected operation is not included in the types of the operations to be performed by the detected object.

20. The method of claim 15, further comprising:
setting a detected time as a time of transmitting the remote control command when the time is detected from the voice command for the remote control before the place; and
setting a current time as the time of transmitting the remote control command when the time is not detected from the voice command for the remote control before the place.
